(19) United States
(12) Patent Application Publication
(10) Pub. No.: US 2026/0178297 A1
(43) Pub. Date: Jun. 25, 2026

(54) AUTOMATIC TRANSFORMATION OF LEGACY SQL-LIKE CODE

(71) Applicant: Royal Bank of Canada, Toronto (CA)

(72) Inventors: Yun ZHAI, Toronto (CA); Wilfredo OLIVEROS, Toronto (CA)

(21) Appl. No.: 19/426,917

(22) Filed: Dec. 19, 2025

Related U.S. Application Data
(60) Provisional application No. 63/736,069, filed on Dec. 19, 2024.

(51) Int. Cl. G06F 8/51

(52) U.S. Cl. CPC G06F 8/51

(57) ABSTRACT

Legacy program applications written in a SQL-like programming language such as FOCUS can be automatically converted to modern languages such as Python/PySpark. The FOCUS files are parsed and translated into SQL statements which can be stored, along with associated metadata, in a transformation configuration file. The configuration file can then be converted into Python/PySpark code.

### RELATED APPLICATIONS

The current application claims priority to U.S. Provisional Patent Application 63/736,069 Filed Dec. 19, 2024 entitled “Automatic Transformation of Legacy FOCUS Code,” the entire contents of which are incorporated herein by reference in their entirety for all purposes.

### TECHNICAL FIELD

The current disclosure relates to the automatic processing of programming code, and in particular to the automatic transformation of legacy SQL-like languages into a modern programming language.

### BACKGROUND

Many organizations or enterprises rely on programs or platforms written in legacy, or outdated, programming languages. While the programs or platforms may be important or critical to the operation of the organizations or enterprises, the uses of legacy programming languages can make maintaining the programs or platforms difficult. Further, the knowledge of the legacy programming languages may be limited making it difficult to modify or improve the programs or platforms.

It is possible to re-write the legacy programs in modern programming languages, however it can be difficult, time-consuming, and costly to manually convert the legacy programs into a modern language.

An additional, alternative and/or improved way to transform legacy programs into a modern programming language is desirable.

### BRIEF DESCRIPTION OF THE DRAWINGS

Further features and advantages of the present disclosure will become apparent from the following detailed description, taken in combination with the appended drawings, in which:

FIG. 1 depicts a system for automatically transforming a legacy SQL-like programming language to a modern programming language;

FIG. 2 depicts the transformation process in FIG. 1

FIG. 3 depicts the process of transforming the legacy SQL-like programming language into an intermediate transformation configuration file;

FIG. 4 depicts the process for parsing the transformation configuration file;

FIG. 5 depicts a process for translating the parsed transformation configuration file; and

FIGS. 6 to 19 are screenshots taken during an example transformation.

### DETAILED DESCRIPTION

In accordance with the present disclosure, there is provided a method of converting a SQL-like language program into a modern programming language program, the method comprising: receiving at a computing system an indication of a SQL-like language program to be converted; parsing a master file of the SQL-like language to generate initialization data; parsing a procedure file of the SQL-like language into logic statements and converting the logic statements into SQL statements; storing the SQL statements in a transformation configuration file; parsing the transformation configuration file and transforming each SQL statement into code in a modern programming language; generating a program by rendering the initialization data and generated code according to a rendering template.

In a further embodiment of the method, the SQL-like language is FOCUS.

In a further embodiment of the method, for each logic statement, the transformation configuration file further stores metadata information about the respective logic statement.

In a further embodiment of the method, the metadata information comprises one or more of: defined input variable of the logic statement; and defined output variable of the logic statement.

In a further embodiment of the method, the transformation configuration file further stores whole project input variables and output variables of the SQL-like language defined in the procedure file.

In a further embodiment of the method, each logic statement is categorized according to a type of SQL statement corresponding to the logic statement.

In a further embodiment of the method, the transformation configuration file stores the type of SQL statement of each logic statement.

In a further embodiment of the method, the modern programming language comprises one of: Python/PySpark; Scala/Spark; and Python/Snowpark.

In accordance with the present disclosure there is further provided a system comprising: a processor for executing instructions; and a memory storing instructions, which when executed configure the system to perform a method comprising: receiving at a computing system an indication of a SQL-like language program to be converted; parsing a master file of the SQL-like language to generate initialization data; parsing a procedure file of the SQL-like language into logic statements and converting the logic statements into SQL statements; storing the SQL statements in a transformation configuration file; parsing the transformation configuration file and transforming each SQL statement into code in a modern programming language; generating a program by rendering the initialization data and generated code according to a rendering template.

In a further embodiment of the system, the SQL-like language is FOCUS.

In a further embodiment of the system, for each logic statement, the transformation configuration file further stores metadata information about the respective logic statement.

In a further embodiment of the system, the metadata information comprises one or more of: defined input variable of the logic statement; and defined output variable of the logic statement.

In a further embodiment of the system, the transformation configuration file further stores whole project input variables and output variables of the SQL-like language defined in the procedure file.

In a further embodiment of the system, each logic statement is categorized according to a type of SQL statement corresponding to the logic statement.

In a further embodiment of the system, the transformation configuration file stores the type of SQL statement of each logic statement.

In a further embodiment of the system, the modern programming language comprises one of: Python/PySpark; Scala/Spark; and Python/Snowpark.

In accordance with the present disclosure there is further provided a non-transitory computer readable memory storing instructions, which when executed by a processor of a system configure the system to perform a method comprising: receiving at a computing system an indication of a SQL-like language program to be converted; parsing a master file of the SQL-like language to generate initialization data; parsing a procedure file of the SQL-like language into logic statements and converting the logic statements into SQL statements; storing the SQL statements in a transformation configuration file; parsing the transformation configuration file and transforming each SQL statement into code in a modern programming language; and generating a program by rendering the initialization data and generated code according to a rendering template.

In a further embodiment of the non-transitory computer readable memory, the SQL-like language is FOCUS.

In a further embodiment of the non-transitory computer readable memory, for each logic statement, the transformation configuration file further stores metadata information about the respective logic statement.

In a further embodiment of the non-transitory computer readable memory, the metadata information comprises one or more of: defined input variable of the logic statement; and defined output variable of the logic statement.

In a further embodiment of the non-transitory computer readable memory, the transformation configuration file further stores whole project input variables and output variables of the SQL-like language defined in the procedure file.

In a further embodiment of the non-transitory computer readable memory, each logic statement is categorized according to a type of SQL statement corresponding to the logic statement.

In a further embodiment of the non-transitory computer readable memory, the transformation configuration file stores the type of SQL statement of each logic statement.

This disclosure describes systems and methods that automatically transform programs written in legacy SQL-like language into modern programming languages. The modern programming language may provide a target execution environment such as Python/PySpark, Scala/Spark, or Python/Snowpark, although other languages or tools may be used including Polars, Flink, Ray, DuckDB. The SQL-like language is a legacy language that expresses SQL-type data transformations and control constructs. Examples of SQL-like languages include for example FOCUS, SAS, and WebFOCUS. The automated transformation of the legacy SQL-like language into a modern programming language uses a two-stage pipeline. First the SQL-like language is parsed to transform logic statements into standardized SQL statements. Logic statements in the legacy SQL-like languages may comprise a delineated unit of legacy procedure logic, which in FOCUS may be bounded by DEFINE FILE/END, TABLEF FILE/END, SET, and IF GOTO blocks, that is parsed and categorized prior to conversion. The SQL statements along with associated metadata may be persisted in an intermediate transformation configuration, which may also be referred to further herein as a configuration file. The intermediate transformation configuration file may provide a language-agnostic file that stores, for each logic statement, a standardized SQL statement and metadata in a structured schema including transformer records and an ETL summary. In some embodiments, the intermediate transformation configuration file conforms to a predefined schema comprising: (i) an ETL summary including an ordered transformer list and optional source and target lists; and (ii) transformer records, each specifying a transformer-type, standardized SQL statement, input and output dataframe names, and metadata fields such as group-by columns, select columns and aliases, table names and aliases, join conditions, and filter conditions. The configuration file can be serialized in HOCON, JSON, YAML, or other file types and may include a schema version identifier to enable reproducible regeneration.

The intermediate transformation configuration file may then be parsed and translated into target code which can be rendered as a deployable program using a target-specific template. The rendering template may provide a target-environment template that parameterizes initialization data and transformation data to render a runnable program. The techniques can be used to automatically convert programs written in legacy SQL-like language in order to replicate the functionality of the legacy program while enabling modern development, review, and deployment tooling. Templates may be implemented using StringTemplate, Jinja2, or equivalent engines, and may be versioned separately from the translator to enable consistent rendering across projects.

Legacy languages can present a large burden to organizations. As described further herein, SQL-like languages such as FOCUS can be automatically transformed into a modern language such as Python or PySpark. Since the transformation is automated, it can be done quickly and efficiently. Further, by transforming the legacy code into a more modern code base, the translated code can be more easily managed and maintained by the organization. The code conversion described further herein automatically parses FOCUS source code including FOCUS procedure file and master layout files and translates them into a modern Python/PySpark source code.

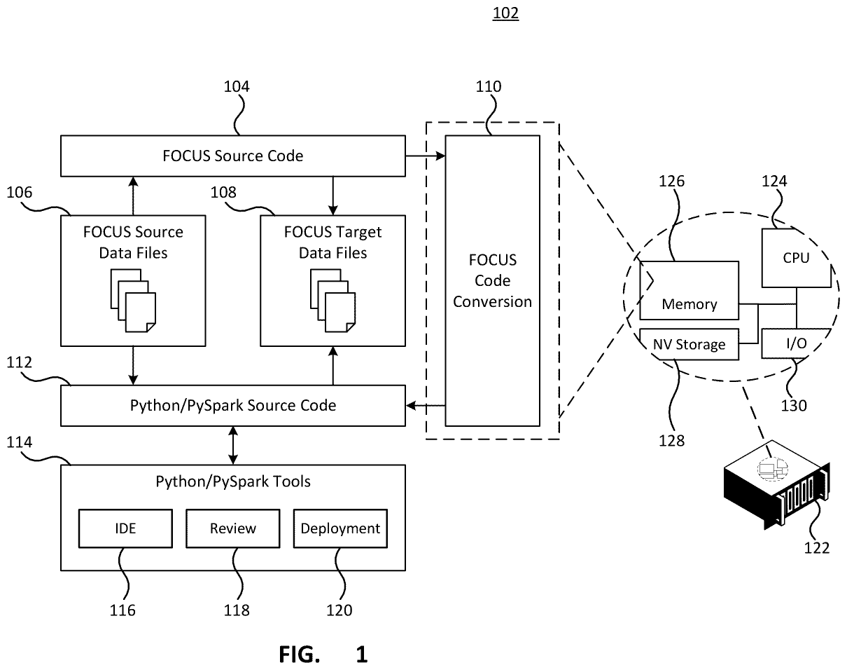

FIG. 1 depicts a system for automatically transforming a legacy SQL-like programming language to a modern programming language. A computer system comprising a processor and memory executes instructions to perform the automated transformation. The system parses legacy SQL-like language files from storage, generates the configuration file, translates the configuration file into target-language source code, and integrates with modern IDE, review, and deployment tools. The system 102 comprises some legacy systems that are programmed in a SQL-like language such as FOCUS. The FOCUS source code 104 is executed by a computing system, such as a mainframe, server, or other computing device. The FOCUS programs provided by executing the FOCUS source code read source data files 106 and generate or update Target data files 108. FOCUS code conversion functionality 110 is used to convert the FOCUS source code into a modern language such as Python/PySpark. The resulting Python/PySpark source code 112 can access the same source data files 106 and generate or update the target data files 108. The functionality provided by the generated Python source code 112 is the same as the functionality provided by the FOCUS source code 104. In addition to providing the same functionality, the Python source code 112 may benefit from other Python/PySpark tools 114 that may be used by the organization. For example, the tools may include an IDE 116 that can be used to maintain, edit, update, etc, the Python source code. Further, the enterprise may have reviewing functionality 118 or processes in place to review the source code, which may be fully automated, partially automated, or manual. Regardless of how the review is performed, since the legacy code is automatically converted into a modern language such as Python, the existing review tools may be easily applied to the generated code. The review process may include, for example, evaluating the generated code in order to determine if it complies with one or more internal, or external guidelines. Other functionality may be provided by the automated, semi-automated, or manual processes that review at least a part of the generated code. Further tools may include deployment tools 120 that can be used to simplify the management of the program including its updating and deployment. It will be appreciated that a wide variety of programming tools can be applied to the automatically generated code.

The FOCUS code conversion functionality 110 can be implemented by a suitably programmed computing system, depicted as a server 122. The server, or computing device, comprises a processor 124 that executes instructions stored in a memory 126. The server may include non-volatile storage 128 as well as one or more input/output (I/O) interfaces that allow other components to be connected to the processor. The instructions stored in the memory, when executed by the processor configure the system 122 to provide the FOCUS code conversion functionality as described in further detail below.

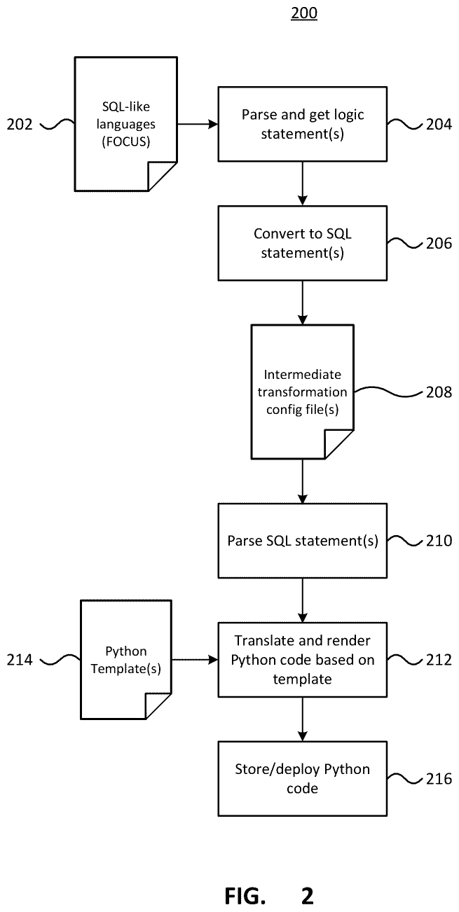

FIG. 2 depicts the transformation process in FIG. 1. The FOCUS code conversion process is described in further detail below. The process reads the FOCUS source files 202 in order to parse relevant metadata and SQL-like logic statements 204. The SQL-like statements of the FOCUS language are converted to SQL statements 206 and combined with the metadata to generate an intermediate transformation configuration file 208. The intermediate transformation configuration file is then processed in order to parse the SQL statements 210 and translate them into Python code which can then be rendered 212 into the Python source code according to a template 214. The generated source code can then be stored and deployed 216.

An enterprise may have a significant amount of FOCUS code with more than 500 lines or even more than 1000 lines per procedure source code. The FOCUS code conversion may be run to automatically process all of the source code to convert the complex FOCUS code to Python/PySpark. The auto-generated Python code is easy to maintain since the generated code is consistent with the same pattern and can conform to a desired template. Further, the auto-generated projects will take much less time and effort to maintain i.e., due to Python or PySpark version upgrades or other changes. Code changes, for example due to a deprecated function that is unsupported for one project can be applied to others in batch for the auto-generated projects.

As described, the conversion process parses FOCUS source code in a two stage pipeline. The system parses FOCUS master and procedure files, categorizes logic statements, converts each logic statement to a standardized SQL statement, and persists each statement and its metadata into an intermediate transformation configuration file comprising an ETL summary and transformer details. The system may then parse each standardized SQL statement from the configuration file, translates it to target-language code, and renders a deployable program using a predefined template. The configuration file can be read to parse the SQL statements, possibly along with associated metadata, and translate them into Python/PySpark. The translated Python/PySpark code can be rendered according to a template to provide the program.

While the conversion process is described with regard to converting FOCUS source code to Python/PySpark, the same approach can be applied for other similar SQL-like languages such as SAS, and WebFOCUS.

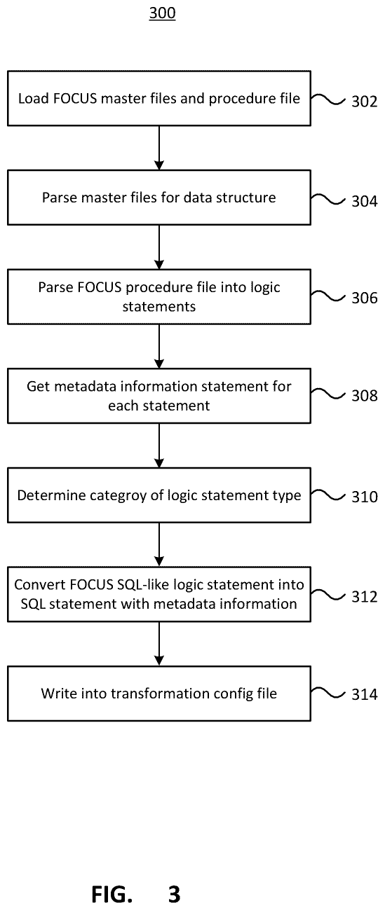

FIG. 3 depicts the process of transforming the legacy SQL-like programming language into an intermediate transformation configuration file. The FOCUS language comprises one or more master files and one or more procedure files. The master files define the data structures while the procedure files define logic statements in a SQL-like language. For each FOCUS project, the conversion loads the FOCUS files (302) including one or more master files, which may have an extension of .mas and a procedure file, which may have an extension of .fex. Once the files are loaded, the master file is parsed to determine the data structure (304), including a list of the column fields, including field type, length, position etc. to get initialization data information. The procedure file is parsed into individual logic statements (306) along with the metadata information for each logic statement including the defined input variable, output variable (308) as well as the input and output variables of the whole project. Each parsed logic statement is categorized according to the SQL equivalent statement type (310), such as SQL INSERT, SQL UPDATE, SET statement and IF GOTO statement etc. Based on the categorization, the SQL-like statements of FOCUS are converted into standard SQL statements (312), along with metadata information of the logic statement. For example, the FOCUS statements FILE DEFINE, TABLE DEFINE, SUM, JOIN etc. are translated into corresponding SQL statements SQL INSERT, SQL UPDATE, JOIN, SET and IF GOTO etc. The converted SQL statement and metadata is written into a transformation configuration file for the FOCUS project. As each logic statement is converted, the SQL statement and metadata can be added to the transformation configuration file (314), or alternatively, each converted statement may be temporarily stored and all converted statements written to the file once all logic statements are converted.

Once the FOCUS files are converted into the transformation configuration file, the configuration file can be processed in order to generate the Python code. The configuration file is parsed and then translated.

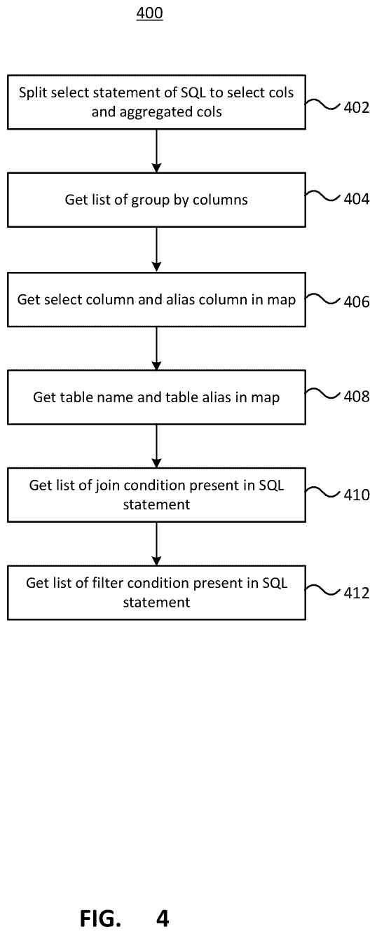

FIG. 4 depicts the process for parsing the transformation configuration file. The configuration file is parsed in order to split SQL SELECT statements in to select columns and aggregated columns (402). The parsing gets a list of group by columns (404), select columns and alias columns in the map (406). The table names, and table aliases, in the map are obtained (408) along with a list of join conditions present in the SQL statement (410) and filter conditions (412) present in the SQL statement.

Once the configuration file is parsed, the resulting information can be translated into Python/PySpark code and rendered as a Python program according to predefined templates. For each transformation element, based on transformation type, the SQL Statement is parsed and translated into Python/PySpark Code

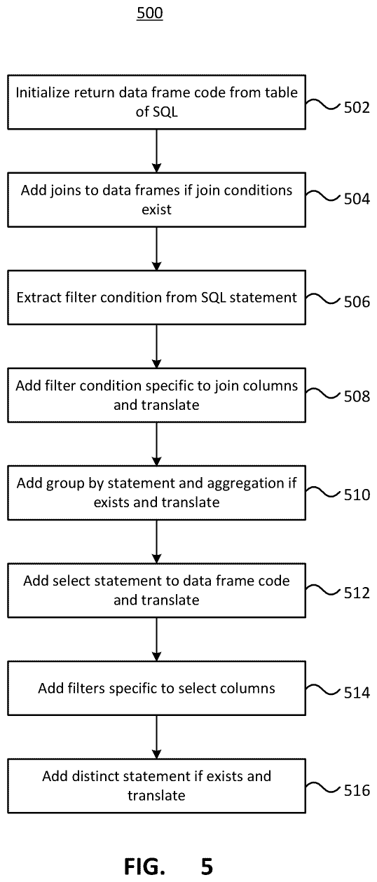

FIG. 5 depicts a process for translating the parsed transformation configuration file. The return data frame is initialized based on the from table of the parse SQL statement (502) and joins are added to the data frames if join conditions exist (504). Filter conditions are extracted from the parsed SQL statement (506) and the filter condition added to specific join columns and translated to Python (508). If group by statements and aggregation exists, they are added and translated to Python (510). The parsed SQL select statement is added to the data frame and translated to Python (512). Filters specific to select columns are added (514) along with distinct statement if it exists and translated to Python (516).

The generated python code can then be rendered into a python program according to a predefined rendering template.

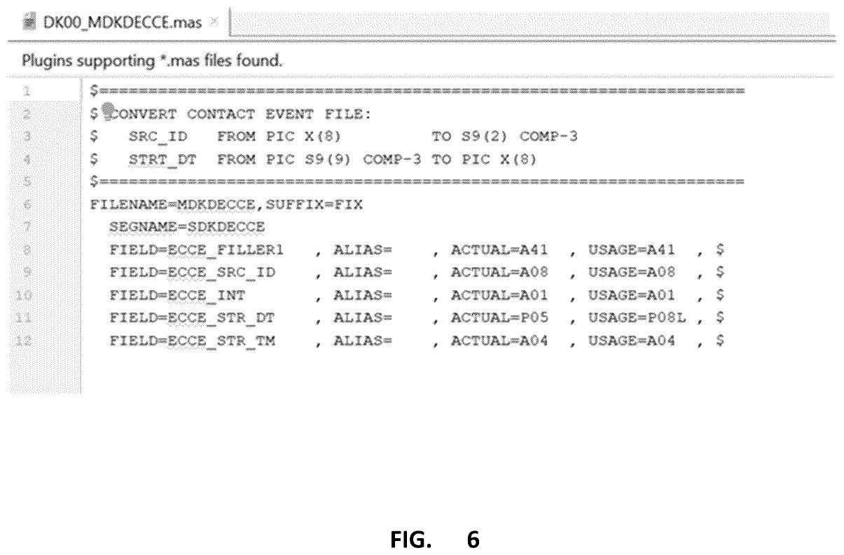

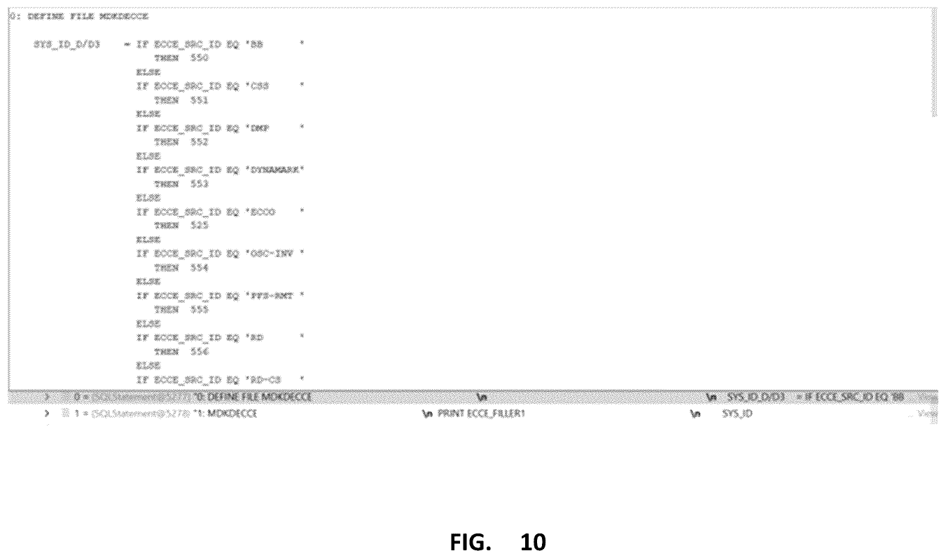

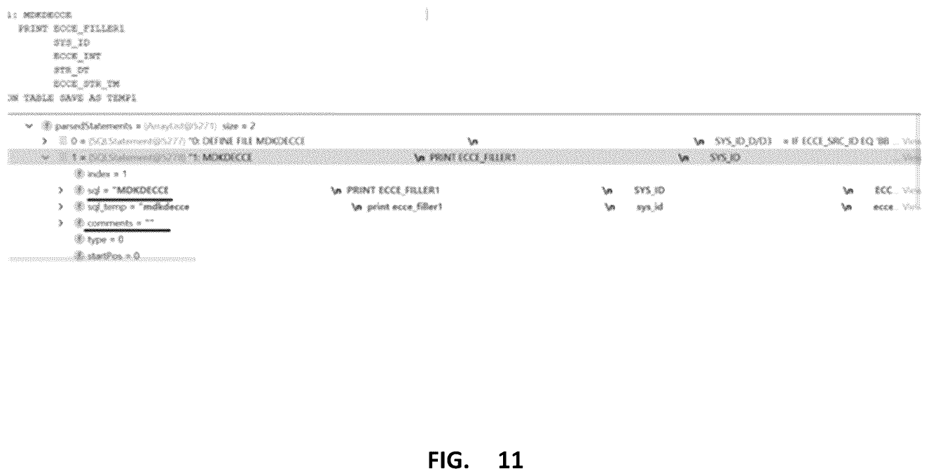

As described above, a FOCUS program or project can be converted into a Python program by first converting the FOCUS program into corresponding SQL statements, and associated metadata, which can be stored in a configuration file. The configuration file is then processed in order to convert the SQL statements and metadata into python code. The generated python code and metadata can then be rendered as a Python program according to a template. An example of the conversion process is described further below with reference to FIGS. 6-19

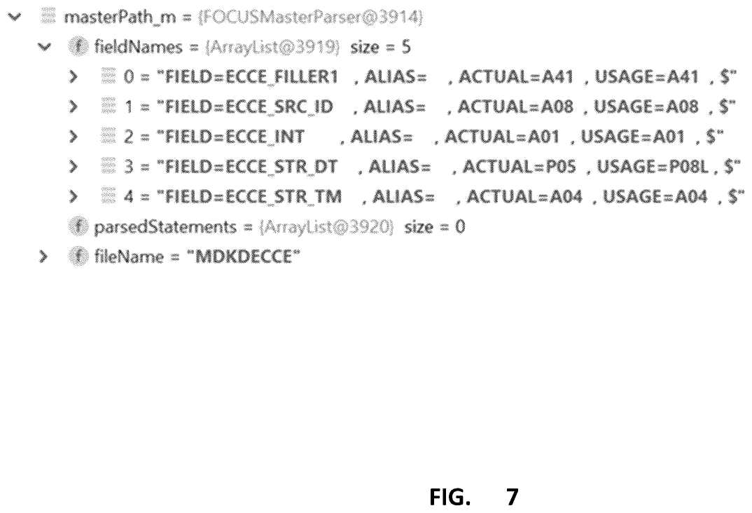

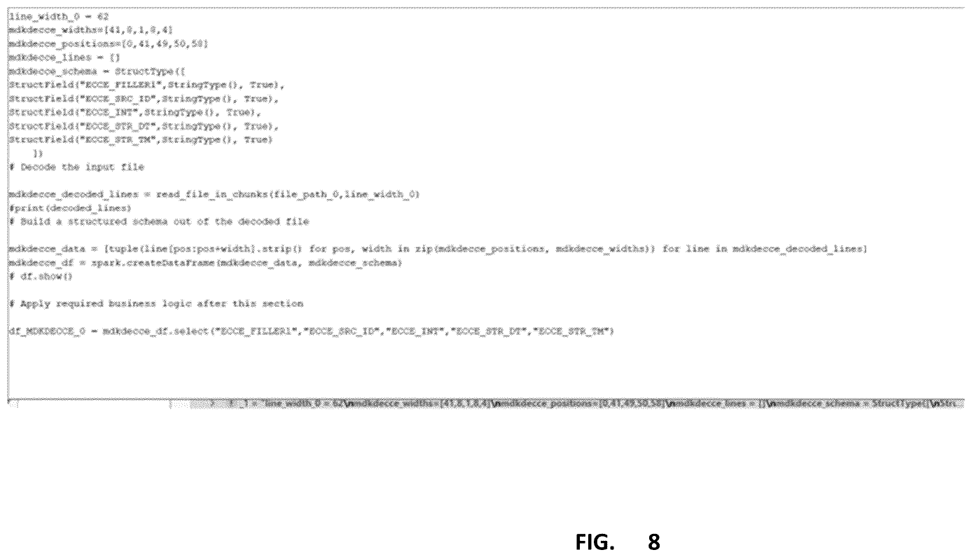

The example project comprises a simple FOCUS master code file named DK00_MDKDECCE.mas and a procedure code file named DK00_IDKFECCE.fex. FIG. 6 depicts the master file DK00_MDKDECCE.mas that defines the data structure. The loaded master file is then parsed to get a list of column field and file names for each master file. The parsing of the Master file is depicted in FIG. 7. Based on the parsed field names, data types and widths, the fields information of the FOCUS mater file are converted into initialization_data for Python/PySpark input file schema related information, which is depicted in FIG. 8.

With the master file processed, the procedure file can be loaded and processed. An illustrative procedure file with 2 logic statements is set out below.

-***********************************************************************
-* FOCEXEC NAME: FDKDECCE
-* JOB NAME : PDKDECC1
-* DESCRIPTION : DAILY RUN FOR EDW ECCO - CONTACT EVENT FILE
-* CONVERT: SRC_ID FROM PIC X(8) TO S9(2) COMP-3
-* STRT_DT FROM PIC S9(9) COMP-3 TO PIC X(8)
-* RUN DATE : OCT 2002
-* CHANGED DATE:

| | |
|---|---|
| -* PROGRAMMER : | Q. CHONG |
| -* CHANGED DATE: | JUN 2011 ( P3132-79 ) |
| -* PROGRAMMER : | D. JIANG |

-* DESCRIPTION : ADD NEW SYS_SRC_ID 060, 073, 085

| | |
|---|---|
| -* CHANGED DATE: | SEP 2012 |
| -* PROGRAMMER : | ZHEN XU |

-* DESCRIPTION : ADD NEW SYS_SRC_ID 770 ( PTR 2790 )

| | |
|---|---|
| -* CHANGED DATE: | AUG 2013 |
| -* PROGRAMMER : | MUHAMMAD BILAL |

-* DESCRIPTION : ADD NEW SYS_SRC_ID 003, 661

| | |
|---|---|
| -* CHANGED DATE: | JAN 2014 |
| -* PROGRAMMER : | ARATI KULKARNI |

-* DESCRIPTION : CHANGED SYS_SRC_ID FROM 003 TO 662

| | |
|---|---|
| -* PROGRAMMER : | ZHEN XU |

-* DESCRIPTION : ADD NEW SYS_SRC_ID 003 (OL-CCA) PTR 3965

| | |
|---|---|
| -* PROGRAMMER : | PAYA KHONDO |

-* DESCRIPTION : ADD NEW SYS_SRC_ID 663 (ZEDD) AND 668(DNH) PTR4494

| | |
|---|---|
| -* CHANGED DATE: | JAN 2015 |

```
-***********************************************************************
-RUN
-*
DEFINE FILE MDKDECCE
  SYS_ID_D/D3 = IF ECCE_SRC_ID EQ ‘BB ’
        THEN 550
      ELSE
      IF ECCE_SRC_ID EQ ‘CSS ’
        THEN 551
      ELSE
      IF ECCE_SRC_ID EQ ‘DMP ’
        THEN 552
      ELSE
      IF ECCE_SRC_ID EQ ‘DYNAMARK’
        THEN 553
      ELSE
      IF ECCE_SRC_ID EQ ‘ECCO ’
        THEN 525
      ELSE
      IF ECCE_SRC_ID EQ ‘OSC-INV ’
        THEN 554
      ELSE
      IF ECCE_SRC_ID EQ ‘PFS-RMT ’
        THEN 555
      ELSE
      IF ECCE_SRC_ID EQ ‘RD ’
        THEN 556
      ELSE
      IF ECCE_SRC_ID EQ ‘RD-CS ’
        THEN 557
      ELSE
      IF ECCE_SRC_ID EQ 'RD-EZMIS’
        THEN 558
      ELSE
      IF ECCE_SRC_ID EQ ‘RD-EZMCT’
        THEN 559
      ELSE
      IF ECCE_SRC_ID EQ ‘RD-EZMTL’
        THEN 560
      ELSE
      IF ECCE_SRC_ID EQ ‘RD-EZWIN’
        THEN 561
      ELSE
      IF ECCE_SRC_ID EQ ‘RD-NDR ’
        THEN 562
      ELSE
      IF ECCE_SRC_ID EQ ‘VOX-MTL ’
        THEN 563
      ELSE
      IF ECCE_SRC_ID EQ ‘VOX-TOR ’
        THEN 564
      ELSE
      IF ECCE_SRC_ID EQ ‘OPTIMA ’
        THEN 565
      ELSE
      IF ECCE_SRC_ID EQ ‘PSCL-RES’
        THEN 566
      ELSE
      IF ECCE_SRC_ID EQ ‘CART ’
        THEN 049
      ELSE
      IF ECCE_SRC_ID EQ ‘SAP-RCT ’
        THEN 060
      ELSE
      IF ECCE_SRC_ID EQ ‘OLB-SM ’
        THEN 073
      ELSE
      IF ECCE_SRC_ID EQ ‘OLB-TMSG’
        THEN 085
      ELSE
      IF ECCE_SRC_ID EQ ‘FRD-PEGA’
        THEN 770
      ELSE
      IF ECCE_SRC_ID EQ ‘TSYS-CTR’
        THEN 662
      ELSE
      IF ECCE_SRC_ID EQ ‘ZEDD ’
        THEN 663
      ELSE
      IF ECCE_SRC_ID EQ ‘DNH ’
        THEN 668
      ELSE
      IF ECCE_SRC_ID EQ ‘OL-CCA ’
        THEN 003
      ELSE
      IF ECCE_SRC_ID EQ ‘CMG ’
        THEN 661
      ELSE 000;
  SYS_ID_D/D3 = IF SYS_ID_D EQ 000
        THEN
        (IF ECCE_SRC_ID EQ ‘CCI ’
          THEN 567)
        ELSE SYS_ID_D;
SYS_ID/A2 = PCKOUT(SYS_ID_D,2,SYS_ID);
STR_DT/A8 = EDIT(ECCE_STR_DT);
END
TABLEF FILE MDKDECCE
  PRINT ECCE_FILLER1
    SYS_ID
    ECCE_INT
    STR_DT
    ECCE_STR_TM
ON TABLE SAVE AS TEMP1
END
```

The procedure file described above defines two logic statements. The first is DEFINE FILE MDKDECCE [ . . . ] END and the second is TABLEF FILE MDKDECCE [ . . . ] END.

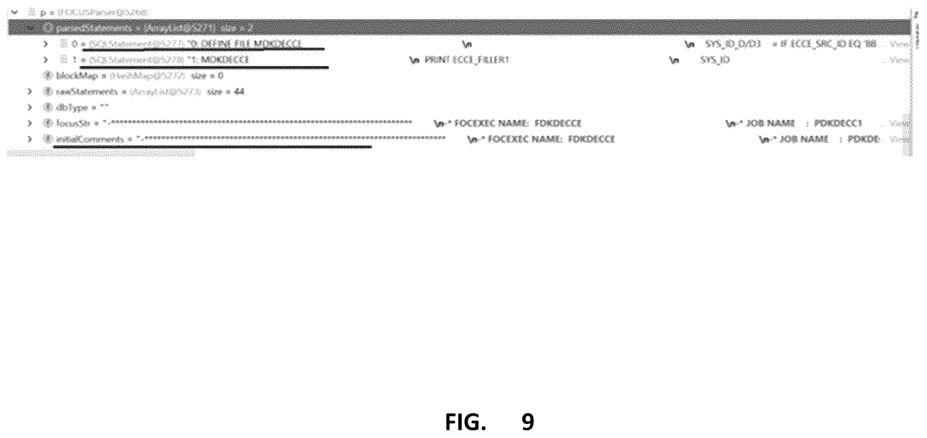

Based on keywords such as DEFINE FILE, TABLEF FILE etc. to identify the logic statement starting point, and keywords such as END etc. to identify the logical statement ending point, the sample FOCUS procedure is parsed into the two logic statements along with the metadata such as the original code comments information. This is depicted in FIGS. 9-11. It is noted that the parsed second logic statement for TABLEF FILE does not include any comments in the FOCUS code.

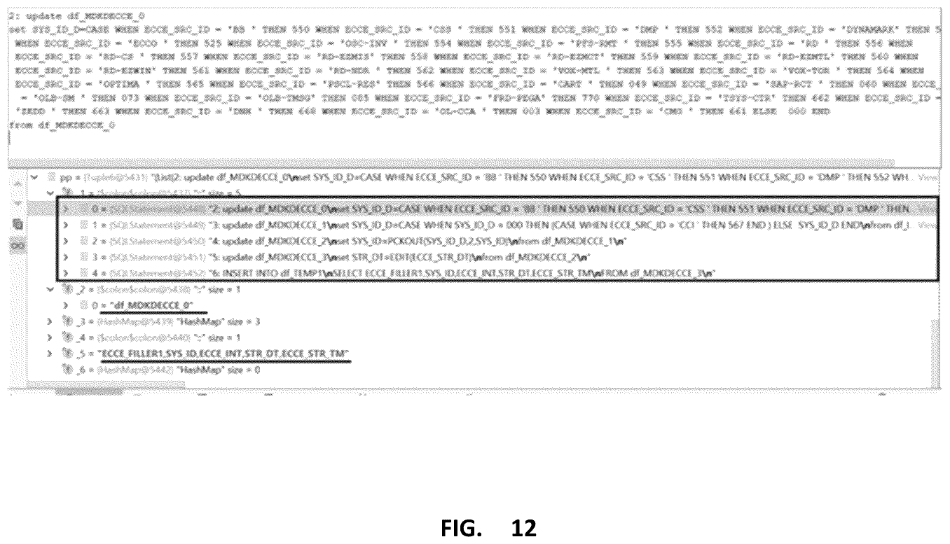

The parsed SQL-like logic statements, along with metadata information, is converted to standardized SQL statements, as depicted in FIG. 12. Each logic statement is parsed based on the logic statement type. For example, for the DEFINE TABLE logic statement, the statement is split by “;” to get a list of column update statements. As highlighted below, the first logic statement is parsed into 4 statements.

| DEFINE FILE MDKDECCE | | | -- statement 1 |
|---|---|---|---|
| SYS_ID_D/D3 | = IF ECCE_SRC_ID EQ ‘BB | ’ | |
| | THEN 550 | | |
| | ELSE | | |
| | IF ECCE_SRC_ID EQ ‘CSS | ’ | |
| | THEN 551 | | |
| | ELSE | | |
| | IF ECCE_SRC_ID EQ ‘DMP | ’ | |
| | THEN 552 | | |
| | ELSE | | |
| | IF ECCE_SRC_ID EQ ‘DYNAMARK | ’ | |
| | THEN 553 | | |
| | ELSE | | |
| | IF ECCE_SRC_ID EQ ‘ECCO | ’ | |
| | THEN 525 | | |
| | ELSE | | |
| | IF ECCE_SRC_ID EQ ‘OSC-INV | ’ | |
| | THEN 554 | | |
| | ELSE | | |
| | IF ECCE_SRC_ID EQ ‘PFS-RMT | ’ | |
| | THEN 555 | | |
| | ELSE | | |
| | IF ECCE_SRC_ID EQ ‘RD | ’ | |
| | THEN 556 | | |
| | ELSE | | |
| | IF ECCE_SRC_ID EQ ‘RD-CS | ’ | |
| | THEN 557 | | |
| | ELSE | | |
| | IF ECCE_SRC_ID EQ ‘RD-EZMIS | ’ | |
| | THEN 558 | | |
| | ELSE | | |
| | IF ECCE_SRC_ID EQ ‘RD-EZMCT | ’ | |
| | THEN 559 | | |
| | ELSE | | |
| | IF ECCE_SRC_ID EQ ‘RD-EZMTL | ’ | |
| | THEN 560 | | |
| | ELSE | | |
| | IF ECCE_SRC_ID EQ ‘RD-EZWIN | ’ | |
| | THEN 561 | | |
| | ELSE | | |
| | IF ECCE_SRC_ID EQ ‘RD-NDR | ’ | |
| | THEN 562 | | |
| | ELSE | | |
| | IF ECCE_SRC_ID EQ ‘VOX-MTL | ’ | |
| | THEN 563 | | |
| | ELSE | | |
| | IF ECCE_SRC_ID EQ ‘VOX-TOR | ’ | |
| | THEN 564 | | |
| | ELSE | | |
| | IF ECCE_SRC_ID EQ ‘OPTIMA | ’ | |
| | THEN 565 | | |
| | ELSE | | |
| | IF ECCE_SRC_ID EQ ‘PSCL-RES | ’ | |
| | THEN 566 | | |
| | ELSE | | |
| | IF ECCE_SRC_ID EQ ‘CART | ’ | |
| | THEN 049 | | |
| | ELSE | | |
| | IF ECCE_SRC_ID EQ ‘SAP-RCT | ’ | |
| | THEN 060 | | |
| | ELSE | | |
| | IF ECCE_SRC_ID EQ ‘OLB-SM | ’ | |
| | THEN 073 | | |
| | ELSE | | |
| | IF ECCE_SRC_ID EQ ‘OLB-TMSG | ’ | |
| | THEN 085 | | |
| | ELSE | | |
| | IF ECCE_SRC_ID EQ ‘FRD-PEGA | ’ | |
| | THEN 770 | | |
| | ELSE | | |
| | IF ECCE_SRC_ID EQ ‘TSYS-CTR | ’ | |
| | THEN 662 | | |
| | ELSE | | |
| | IF ECCE_SRC_ID EQ ‘ZEDD | ’ | |
| | THEN 663 | | |
| | ELSE | | |
| | IF ECCE_SRC_ID EQ ‘DNH | ’ | |
| | THEN 668 | | |
| | ELSE | | |
| | IF ECCE_SRC_ID EQ ‘OL-CCA | ’ | |
| | THEN 003 | | |
| | ELSE | | |
| | IF ECCE_SRC_ID EQ ‘CMG | ’ | |
| | THEN 661 | | |
| | ELSE 000; | | |
| SYS_ID_D/D3 | = IF SYS_ID_D EQ 000 | | -- statement 2 |
| | THEN | | |
| | (IF ECCE_SRC_ID EQ ‘CCI | ’ | |
| | THEN 567) | | |
| | ELSE SYS_ID_D; | | |

| | |
|---|---|
| SYS_ID/A2 = PCKOUT(SYS_ID_D,2,SYS_ID); | -- statement 3 |
| STR_DT/A8 = EDIT(ECCE_STR_DT); | -- statement 4 |

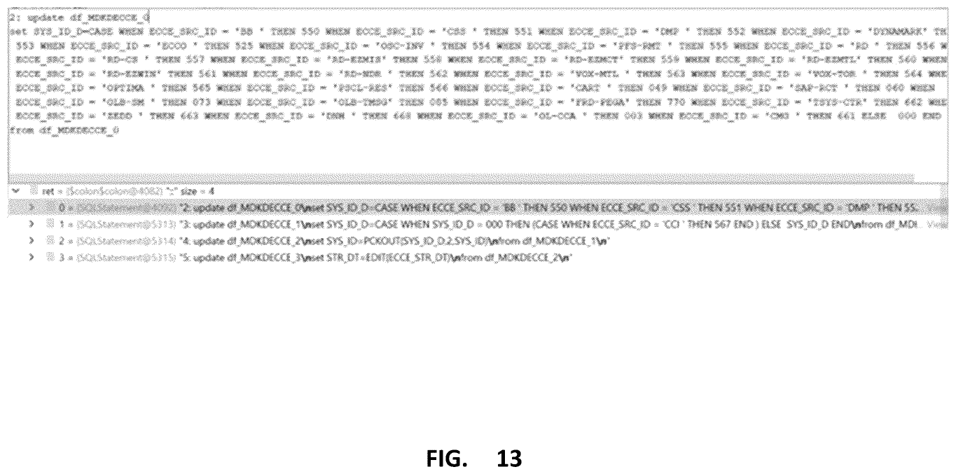

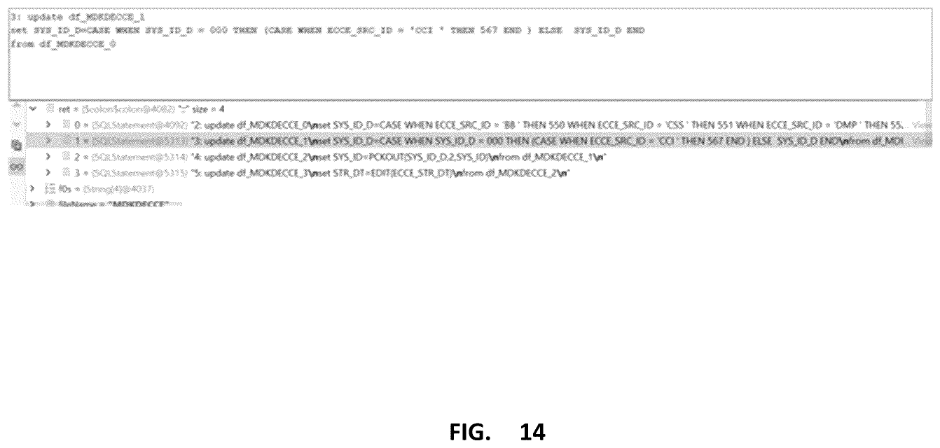

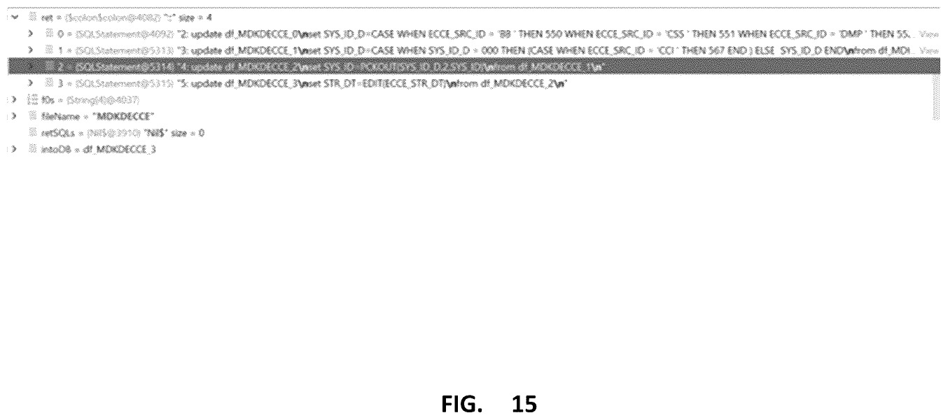

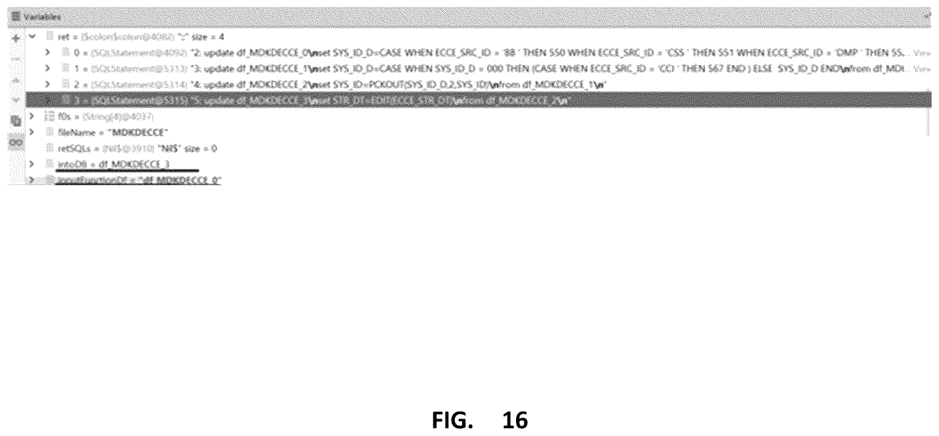

For each DEFINE TABLE column update statement, the statement is converted into a SQL UPDATE statement. FIG. 13 depicts the SQL UPDATE for statement 1, FIG. 14 depicts the SQL UPDATE for statement 2, FIG. 15 depicts the SQL UPDATE for statement 3, and FIG. 16 depicts the SQL UPDATE for statement 4. The example DEFINE TABLE logic statement is converted into four SQL UPDATE statements with input dataframe variable “df_MDKDECCE_0” and output data frame variable “df_MDKDECCE_3” metadata information for context metadata definition. Variable Df_MDKDECCE_0 name comes from DEFINE FILE MDKDECCE. DEFINE FILE, TABLE FILE, ON TABLE SAVE AS etc., are used with the file/table name to define corresponding variable names with an index. If no MDKDECCE-related metadata is defined in the previous statement, the input variable is defined as df_MDKDECCE_0, ending with index 0. The index value is increased for each subsequent SQL UPDATE statement, and the current SQL UPDATE statement's INTO table variable is as the next UPDATE statement's FROM table variable.

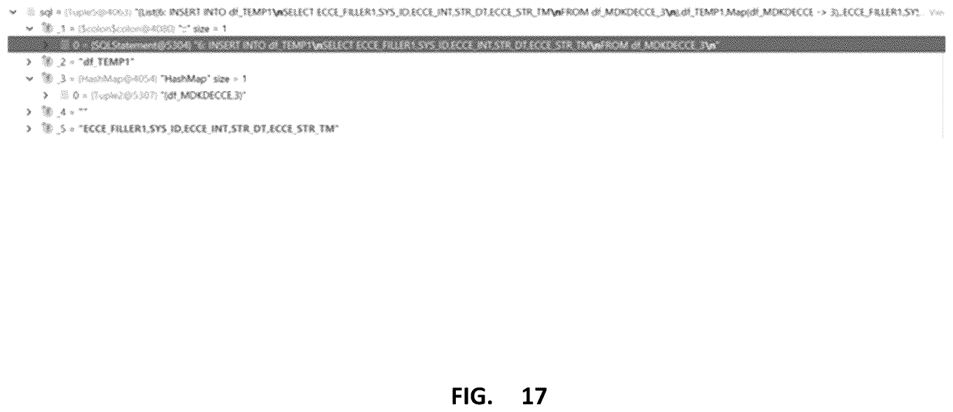

For the logic statement TABLEF TABLE NAME, it is converted into INSERT INTO SQL statements. INSERT INTO SQL statement FROM table metadata Df_MDKDECCE_3, which is passed from the previously processed statement. INTO table variable df_TEMP1 comes from TABLE FILE logic statement ON TABLE SAVE AS TEMP1. The converted statement is depicted in FIG. 17.

For logic statements of JOIN, IF GOTO, or SET, the converted SQL statement will be the same as the logic statement. Once the FOCUS files have been converted into SQL-like statements, the list of converted SQL statements, along with any metadata, transformation type, and other information, is written into an intermediate configuration file. This intermediate configuration file is the bridge between the source FOCUS code and the target Python/PySpark code. It is independent of both the source and target programming languages. The intermediate configuration file corresponding to the FOCUS code above is provided below.

```
etl-summary {
etl-name = “DK00_IDKFECCE”
transformer-list = [
“df_MDKDECCE_0”, “df_MDKDECCE_1”, “df_MDKDECCE_2”, “df_MDKDECCE_3”, “df_TEMP1”
]
source-list = [
]
target-list = [
]
}
etl-details{
  transformers {
df_MDKDECCE_0 {
  transformer-type = “EXECUTE_SQL_UPDATE”
  output-df-name = “df_MDKDECCE_0”
  spark-sql-query = “““
update df_MDKDECCE_0
set SYS_ID_D=CASE WHEN ECCE_SRC_ID = ‘BB ’ THEN 550 WHEN ECCE_SRC_ID = ‘CSS ’ THEN
551 WHEN ECCE_SRC_ID = ‘DMP ’ THEN 552 WHEN ECCE_SRC_ID = ‘DYNAMARK’ THEN 553 WHEN
ECCE_SRC_ID = ‘ECCO ’ THEN 525 WHEN ECCE_SRC_ID = ‘OSC-INV ’ THEN 554 WHEN
ECCE_SRC_ID = ‘PFS-RMT’ THEN 555 WHEN ECCE_SRC_ID = ‘RD ’ THEN 556 WHEN ECCE_SRC_ID
= ‘RD-CS ’ THEN 557 WHEN ECCE_SRC_ID = ‘RD-EZMIS’ THEN 558 WHEN ECCE_SRC_ID = ‘RD-
EZMCT’ THEN 559 WHEN ECCE_SRC_ID = ‘RD-EZMTL’ THEN 560 WHEN ECCE_SRC_ID = ‘RD-
EZWIN’ THEN 561 WHEN ECCE_SRC_ID = ‘RD-NDR ’ THEN 562 WHEN ECCE_SRC_ID = ‘VOX-MTL ’
THEN 563 WHEN ECCE_SRC_ID = ‘VOX-TOR ’ THEN 564 WHEN ECCE_SRC_ID = ‘OPTIMA ’ THEN
565 WHEN ECCE_SRC_ID = ‘PSCL-RES’ THEN 566 WHEN ECCE_SRC_ID = ‘CART ’ THEN 049 WHEN
ECCE_SRC_ID = ‘SAP-RCT ’ THEN 060 WHEN ECCE_SRC_ID = ‘OLB-SM ’ THEN 073 WHEN
ECCE_SRC_ID = ‘OLB-TMSG’ THEN 085 WHEN ECCE_SRC_ID = ‘FRD-PEGA’ THEN 770 WHEN
ECCE_SRC_ID = ‘TSYS-CTR’ THEN 662 WHEN ECCE_SRC_ID = ‘ZEDD ’ THEN 663 WHEN
ECCE_SRC_ID = ‘DNH ’ THEN 668 WHEN ECCE_SRC_ID = ‘OL-CCA ’ THEN 003 WHEN ECCE_SRC_ID
= ‘CMG ’ THEN 661 ELSE 000 END
from df_MDKDECCE_0
  ”””
  },
df_MDKDECCE_1 {
  transformer-type = “EXECUTE_SQL_UPDATE”
  output-df-name = “df_MDKDECCE_1”
  spark-sql-query = “““
update df_MDKDECCE_1
set SYS_ID_D=CASE WHEN SYS_ID_D = 000 THEN (CASE WHEN ECCE_SRC_ID = ‘CCI ’ THEN 567
END ) ELSE SYS_ID_D END
from df_MDKDECCE_0
  ”””
},
df_MDKDECCE_2 {
  transformer-type = “EXECUTE_SQL_UPDATE”
  output-df-name = “df_MDKDECCE_2”
  spark-sql-query = “““
update df_MDKDECCE_2
set SYS_ID=PCKOUT(SYS_ID_D,2,SYS_ID)
from df_MDKDECCE_1
  ”””
  },
df_MDKDECCE_3 {
  transformer-type = “EXECUTE_SQL_UPDATE”
  output-df-name = “df_MDKDECCE_3”
  spark-sql-query = “““
update df_MDKDECCE_3
set STR_DT=EDIT(ECCE_STR_DT)
from df_MDKDECCE_2
  ”””
  },
df_TEMP1 {
  transformer-type = “EXECUTE_SQL_INSERT”
  output-df-name = “df_TEMP1”
  spark-sql-query = “““
INSERT INTO df_TEMP1
SELECT ECCE_FILLER1,SYS_ID,ECCE_INT,STR_DT,ECCE_STR_TM
FROM df_MDKDECCE_3
  ”””
  }
  }
}
etl-details{
sources{
}
}
etl-details{
targets{
}
}
```

The configuration file may include an etl-summary section providing a transformer-list and optional source/target lists, as well as an etl-details section containing transformer records. Each transformer record can include fields such as transformer-type, spark-sql-query, output-df-name, and additional metadata. In the configuration file, transforms include transformer-type, spark-sql-query, and output-df-name, etc. The transformer-type may be a required field, while spark-sql-query and output-df-name may be optional fields. The transformers data structure may be defined as below:

```
case class TransformerData (
    dfName: Option[String],
    transformerType: String,
    assignStatement: Option[String],
    jobName: Option[String],
    dsName: Option[String],
    ifCondition: Option[String],
    thenStatement : Option[String],
  // doCondition : Option[String],
  // untilCondition : Option[String],
    whileCondition : Option[String],
    loopStatement: Option[String],
    inputDfName: Option[String],
    outputDfName: Option[String],
    leftDfName : Option[String],
    rightDfName : Option[String],
    joinType : Option[String],
    dateFormat : Option[String],
    joinColumns : Option[List[String]],
    sparkSqlQuery : Option[String],
    sourceColumns: Option[List[String]],
    pivotByColumn: Option[String],
    pivotColumns: Option[String],
    groupByColumns: Option[List[String]],
    aggFunctions: Option[List[String]],
    colName : Option[String],
    addColPrefix: Boolean = false,
    joinDfs: Option[List[String]],
    joinToSource: Boolean = false,
    fillValue: Option[String],
    cols: Option[List[String]],
    skipTransformation: Boolean = false,
    castTo: Option[String],
    comments:Option[String])
```

Where:
assignmentStatement: for assignment statement
ifCondition & thenStatement: for if then statement
whileCondition & loopStatement: for while loop statement
leftDfName, rightDfName, joinType & joinColumns: for Join statement
sparkSqlQuery and outputDfName: for SET, SQL INSERT, SQL UPDATE statements
pivotByColumn, pivotColumns: for pivot statement
groupByColumns & aggFunctions: for aggregation statement
comments: for original source code comments

The transformation data structure stores the transformation and metadata for all logic statements from the FOCUS source code. This structure serves as a source-code-independent starting point for translation into the target code. For each transformation element in the config file, the SQL statement is translated to Python/PySpark based on its transformation type, and the result is appended to the ‘ret’ variable used for the template's ‘transformation_data’, as highlighted below.

If the transformation type is SQL UPDATE, for example:

update df_MDKDECCE_0
set SYS_ID_D=CASE WHEN ECCE_SRC_ID = ‘BB ’ THEN 550 WHEN ECCE_SRC_ID = ‘CSS ’ THEN
551 WHEN ECCE_SRC_ID = ‘DMP ’ THEN 552 WHEN ECCE_SRC_ID = ‘DYNAMARK’ THEN 553
WHEN ECCE_SRC_ID = ‘ECCO ’ THEN 525 WHEN ECCE_SRC_ID = ‘OSC-INV ’ THEN 554 WHEN
ECCE_SRC_ID = ‘PFS-RMT ’ THEN 555 WHEN ECCE_SRC_ID = ‘RD ’ THEN 556 WHEN
ECCE_SRC_ID = ‘RD-CS ’ THEN 557 WHEN ECCE_SRC_ID = ‘RD-EZMIS’ THEN 558 WHEN
ECCE_SRC_ID = ‘RD-EZMCT’ THEN 559 WHEN ECCE_SRC_ID = ‘RD-EZMTL’ THEN 560 WHEN
ECCE_SRC_ID = ‘RD-EZWIN’ THEN 561 WHEN ECCE_SRC_ID = ‘RD-NDR ’ THEN 562 WHEN
ECCE_SRC_ID = ‘VOX-MTL ’ THEN 563 WHEN ECCE_SRC_ID = ‘VOX-TOR ’ THEN 564 WHEN
ECCE_SRC_ID = ‘OPTIMA ’ THEN 565 WHEN ECCE_SRC_ID = ‘PSCL-RES’ THEN 566 WHEN
ECCE_SRC_ID = ‘CART ’ THEN 049 WHEN ECCE_SRC_ID = ‘SAP-RCT ’ THEN 060 WHEN
ECCE_SRC_ID = ‘OLB-SM ’ THEN 073 WHEN ECCE_SRC_ID = ‘OLB-TMSG’ THEN 085 WHEN
ECCE_SRC_ID = ‘FRD-PEGA’ THEN 770 WHEN ECCE_SRC_ID = ‘TSYS-CTR’ THEN 662 WHEN
ECCE_SRC_ID = ‘ZEDD ’ THEN 663 WHEN ECCE_SRC_ID = ‘DNH ’ THEN 668 WHEN
ECCE_SRC_ID = ‘OL-CCA ’ THEN 003 WHEN ECCE_SRC_ID = ‘CMG ’ THEN 661 ELSE 000 END
from df_MDKDECCE_0

The transformation process is as follows.

Step 1: Convert the SQL UPDATE to a SQL SELECT statement. A sample conversion from SQL UPDATE to SQL SELECT is shown below:

Select CASE WHEN ECCE_SRC_ID = ‘BB ’ THEN 550 WHEN ECCE_SRC_ID = ‘CSS ’ THEN 551
WHEN ECCE_SRC_ID = ‘DMP ’ THEN 552 WHEN ECCE_SRC_ID = ‘DYNAMARK’ THEN 553 WHEN
ECCE_SRC_ID = ‘ECCO ’ THEN 525 WHEN ECCE_SRC_ID = ‘OSC-INV ’ THEN 554 WHEN
ECCE_SRC_ID = ‘PFS-RMT ’ THEN 555 WHEN ECCE_SRC_ID = ‘RD ’ THEN 556 WHEN
ECCE_SRC_ID = ‘RD-CS ’ THEN 557 WHEN ECCE_SRC_ID = ‘RD-EZMIS’ THEN 558 WHEN
ECCE_SRC_ID = ‘RD-EZMCT’ THEN 559 WHEN ECCE_SRC_ID = ‘RD-EZMTL’ THEN 560 WHEN
ECCE_SRC_ID = ‘RD-EZWIN’ THEN 561 WHEN ECCE_SRC_ID = ‘RD-NDR ’ THEN 562 WHEN
ECCE_SRC_ID = ‘VOX-MTL ’ THEN 563 WHEN ECCE_SRC_ID = ‘VOX-TOR ’ THEN 564 WHEN
ECCE_SRC_ID = ‘OPTIMA ’ THEN 565 WHEN ECCE_SRC_ID = ‘PSCL-RES’ THEN 566 WHEN
ECCE_SRC_ID = ‘CART ’ THEN 049 WHEN ECCE_SRC_ID = ‘SAP-RCT ’ THEN 060 WHEN
ECCE_SRC_ID = ‘OLB-SM ’ THEN 073 WHEN ECCE_SRC_ID = ‘OLB-TMSG’ THEN 085 WHEN
ECCE_SRC_ID = ‘FRD-PEGA’ THEN 770 WHEN ECCE_SRC_ID = ‘TSYS-CTR’ THEN 662 WHEN
ECCE_SRC_ID = ‘ZEDD ’ THEN 663 WHEN ECCE_SRC_ID = ‘DNH ’ THEN 668 WHEN
ECCE_SRC_ID = ‘OL-CCA ’ THEN 003 WHEN ECCE_SRC_ID = ‘CMG ’ THEN 661 ELSE 000 END
as SYS_ID_D from df_MDKDECCE_0

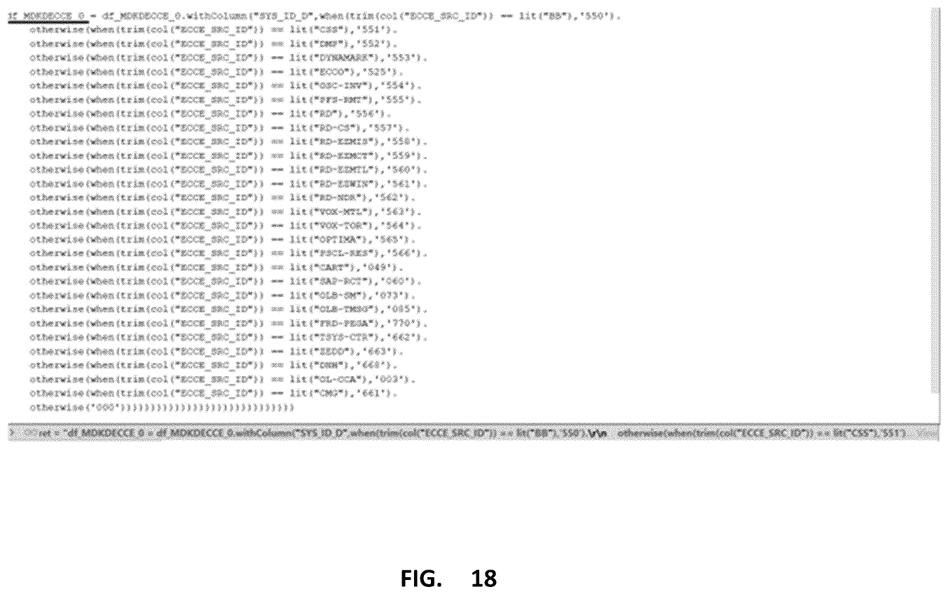

Step 2: Parse & translate SQL SELECT Statement to Python/PySpark. Next, assign the UPDATE table variable to the generated code and append to ret. This is depicted in FIG. 18.

If transformation type is SQL INSERT, For example:
INSERT INTO df_TEMP1
SELECT ECCE_FILLER1,SYS_ID,ECCE_INT,STR_DT,ECCE_STR_TM FROM df_MDKDECCE_3

The transformation process first converts the SQL INSERT to SQL SELECT statement, as follows:
SELECT ECCE_FILLER1,SYS_ID,ECCE_INT,STR_DT,ECCE_STR_TM
FROM df_MDKDECCE_3

Next, the SQL Select is parsed and translated into Python/PySpark code. The example generated code from SQL SELECT statement is:
df_MDKDECCE_3.select (col (“ECCE_FILLER1”), col (“SYS_ID”), col (“ECCE_INT”), col (“STR_DT”), col (“ECCE_STR_TM”))

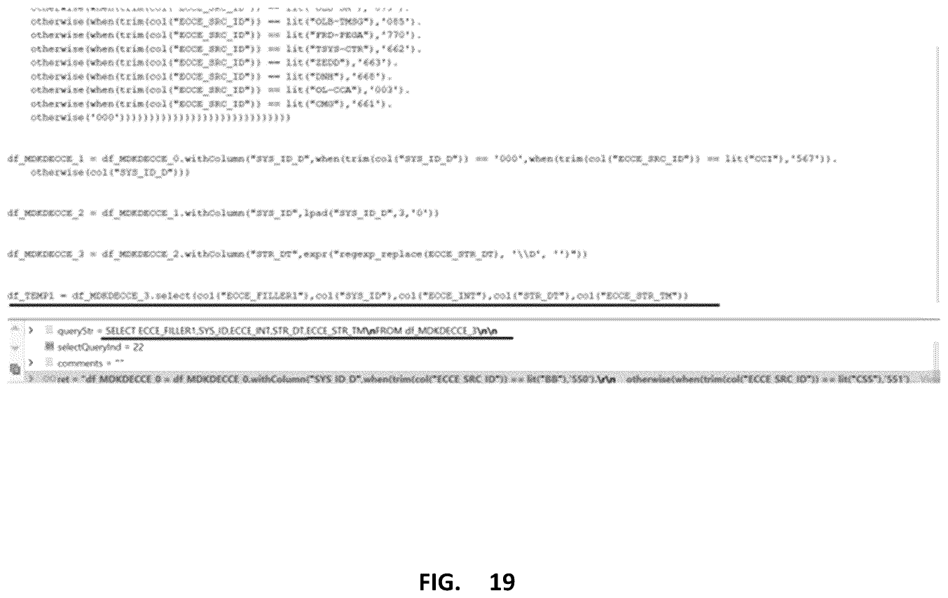

The INTO table variable is assigned to the generated code and append to ret variable as depicted in FIG. 19.

The configuration file may provide a directed dataflow via input and output dataframe names and supports diverse transformation types including SQL UPDATE, SQL INSERT, JOIN, SET, IF GOTO, aggregation, and pivot. The system can deterministically assign dataframe variable names using table/file identifiers with monotonic index incrementation. The output dataframe of statement i may be passed as the input dataframe of statement i+1, encoding a reproducible pipeline state across the transformer sequence (e.g., df_MDKDECCE_0→df_MDKDECCE_1→ . . . →df_n). In certain embodiments, dataframe variable names are deterministically assigned by concatenating a table or file identifier with a monotonically increasing index.

The SQL statements of the transformers in the configuration file are parsed and translated into Python code. The generated code may be validated, for example using a call to the open source JSqlParser framework CCJSqlParserUtil.parse (sql).

SQL statements may be parsed by splitting the select statement of SQL to select columns and aggregated columns. The parser splits SELECT statements into select and aggregated columns, collects group-by columns, records table names and aliases, and extracts join and filter conditions. The parser preserves logical relationships to enable faithful translation to target code. When parsing the SQL SELECT statement, a list of group by columns is obtained along with select columns and alias columns in the map. Further, the parsing gets table name and table alias, a list of join conditions in the SQL statement and a list of filter conditions in the SQL statement. Once parsed, the information can be translated.

The translation begins by initializing a return dataframeCode variable and adding to it based on the from table of the SQL. If the from table is nested, then the translation creates a new dataframeCode for the nested statement and translates it into PySpark pseudo code as below:

```
  If from table is nested => dataFrameCode +=
nestedTableName as alias
  Else if have alias name => dataFrameCode =
tableName as alias
  Else
```

Any joins in the SQL statement are added if join conditions exist as highlighted in the following pseudocode.

If join right is nested => dataFrameCode +=
join(nestedTableName.as(fromTableAlias),
leftCondition === rightCondition, JoinType)
Else => dataFrameCode +=
join(TableName.as(tableAlias),conditions.concatenate(“
&&”),JoinType)

Filter conditions are extracted from the SQL statement, and converted to the dataframe specific filters as follows:

```
If filter condition contains “not in” => dataFrameCode
+=.filter(
    preIn.isin(Array{postIn}:_*)
    Else if condition contains “between” =>
dataFrameCode +=.filter(
  preBetween.between(firstElement,secondElement))
    Else if condition contains “in” =>
dataFrameCode +=.filter(
    ~col(preIn).isin(postIn))
    Else if condition contains “is not null” =>
dataFrameCode+=.filter(
    conditionVar.isNotNull)
    Else if condition contains “is null” =>
dataFrameCode+=.filter(
    conditionVar.isNull)
```

The filter conditions can then be added to specific join columns as follows:

```
For each join filter condition => dataFrameCode
+=.filter(joinCondition)
Add groupBy statement and aggregation if exists
Pseudocode to translate into PySpark as below:
  dataFrameCode +=.groupBy(groupByColumns)
  dataFrameCode
+=.agg(aggCol.alias({selectColsAlias(col)}))
```

The select statement is added to the dataframeCode as follows

For each of select columns =>
If it is a function, convert function
If it is a variable, convert variable
If it is a column name, translate into col( with
column name )

When translating from the SQL statement to Python code, it may be necessary to translate variables. This can be done according to:

If variable is Date => date( )
Else if it is column name => col( )
Else if it is a numeric variable with starting 0 =>
“’” + col + “’”
Else if it starts with ‘ => lit
Else => col

Similarly, it may be necessary to translate functions. This can be accomplished using a function mapping between SQL functions and Python/PySpark functions. A sample mapping of functions is provided in Table 1 below.

TABLE 1

| SQL Function | PySpark |
|---|---|
| case when | When . . . otherwise |
| edit | Expr(regexp_replace) |
| PCKOUT | lpad |
| Ctran | translate |
| Lag | Col( ).over(window) |
| I | If arguments > 2 => Concat; |
| | Else if is a Date Column => date_add; |
| | Else => + |

Filters specific to select columns are added as follows:
For each of filter in select filters=>dataFrameCode+=.filter (filterCond)

A distinct statement can be added as follows:
If sql contains distinct=>dataFrameCode+=.distinct ( )

For transformations in the configuration file that have the type SET statement, the transformation is parsed by getting the set statement variable name and value. The statement can then be translated by getting the most outer function for the variable value according to:
If it is a function, get the corresponding mapping function.
Else=>variable value

For transformations in the configuration file that have the type IF GOTO statement, the transformation is parsed by getting the if statement and the go to block. The parsed statement can then be translated according to:

For IF statement => replace EQ to ==, NE to !=, LE to
<= etc.
For each statement in block =>
If it is a QUIT statement, convert it to .xit
Else if it is a SET statement, parse and convert the set
statement.
Else if it is a FIN or END statement, convert it to exit(0).

For example, the following IF GOTO statement:
IF &RECORDS EQ &READS GOTO NOREJECT;
QUIT FOCUS 0004
NOREJECT
IF &RECORDS GT 0 GOTO GOODRECS;
QUIT FOCUS 0004
GOODRECS
IF &RECORDS LE 99999999 GOTO GOODEND;
QUIT FOCUS 0004
GOODEND
is translated into the following Python/PySpark code:

```
RECORDS = df_OUTFILE.count( )
READS = df_OUTFILE.rdd.count( )
if RECORDS == READS:
  if RECORDS > 0:
    if RECORDS <= 99999999:
      exit(0)
    exit(4)
  exit(4)
exit(4)
```

Once the configuration file is parsed and translated into Python code, it can be rendered into a Python program based on a template. The variables from the initialization_data from parsing the master file and the transformation_data from translating the configuration file are rendered according to a template. An illustrative template code for rendering is provided below.

```
loadPysparkTemplate(initialization_data,
transformation_data, pdf_import, ifgotoexit_data) ::= <<
from pyspark.sql import SparkSession
from pyspark.sql.functions import col, sum, when, lag,
coalesce, concat, expr, lit, last, trim,
regexp_replace,monotonically_increasing_id, length, lpad,
rpad, format_number
from pyspark.sql.types import StructType, StructField,
StringType, DoubleType, DecimalType
from pyspark.sql.window import Window
import codecs
import sys
import os
#pdf_import#
def read_file_in_chunks(file_path,line_width):
  lines = [ ]
  with open(file_path, ‘rb’) as f:
    while True:
        chunk = f.read(line_width)
        if not chunk:
            break
        line = chunk.decode(‘cp1047’,
errors=‘replace’).rstrip(‘\O’)
        lines.append(line)
  return lines
def write_aggregated_data(aggregated_data_formatted,
outfile_path, encoding=“cp1047”):
  output_rdd = aggregated_data_formatted.rdd.map(lambda
row: “”.join([str(cell) for cell in row]))
  with codecs.open(outfile_path,“w”, encoding=encoding)
as file:
      for line in output_rdd.collect( ):
          “““
          if len(line) <= 80:
              file.write(line + ‘ ’ * (80-len(line)))
          else:
              print(“line is truncated to 80 length”)
              file.write(line[0:80])
          ”””
          file.write(line)
print (‘Number of arguments:’, len(sys.argv), ‘arguments.’)
#initialization_data#
#transformation_data#
#ifgotoexit_data#
spark.stop( )
>>
```

The resulting Python program code for the example FOCUS project described above is provided below.

#**********************************************************
********
# This Python/PySpark code is Auto Generated
# Generated By: Nova Migration Service Focus to
Python/PySpark Convert API
# API Build Version: 1.0.8
# API Build Date: 2024-09-27
# Python/PySpark Generated Date: 2024-10-08
#**********************************************************
********
#**********************************************************
************

| | | |
|---|---|---|
| # FOCEXEC NAME | : | FDKDECCE |
| # JOB NAME | : | PDKDECC1 |
| # DESCRIPTION | : | DAILY RUN FOR EDW ECCO - CONTACT EVENT |

FILE

| | |
|---|---|
| # | CONVERT: SRC_ID FROM PIC X (8) TO S9 (2) |
| COMP-3 | STRT_DT FROM PIC S9 (9) COMP-3 TO |

#
PIC X (8)

| # RUN DATE | : | OCT 2002 |
|---|---|---|
| # CHANGED DATE | : | |
| # PROGRAMMER | : | J. SMITH |
| # CHANGED DATE | : | JUN 2011 ( P3132-79 ) |
| # PROGRAMMER | : | J. SMITH |
| # DESCRIPTION | : | ADD NEW SYS_SRC_ID 060, 073, 085 |
| # CHANGED DATE | : | SEP 2012 |
| # PROGRAMMER | : | J. SMITH |
| # DESCRIPTION | : | ADD NEW SYS_SRC_ID 770 ( PTR 2790 ) |
| # CHANGED DATE | : | AUG 2013 |
| # PROGRAMMER | : | J. SMITH |
| # DESCRIPTION | : | ADD NEW SYS_SRC_ID 003, 661 |
| # CHANGED DATE | : | JAN 2014 |
| # PROGRAMMER | : | J. SMITH |
| # DESCRIPTION | : | CHANGED SYS_SRC_ID FROM 003 TO 662 |
| # PROGRAMMER | : | J. SMITH |
| # DESCRIPTION | : | ADD NEW SYS_SRC_ID 003 (OL-CCA) PTR 3965 |
| # PROGRAMMER | : | J. SMITH |
| # DESCRIPTION | : | ADD NEW SYS_SRC_ID 663 (ZEDD) AND 668 (DNH) |

PTR4494

| | | |
|---|---|---|
| # CHANGED DATE | : | JAN 2015 |

```
#**********************************************************
************
#
from pyspark.sql import SparkSession
from pyspark.sql.functions import col, sum, when, lag,
coalesce, concat, expr, lit, last, trim,
regexp_replace,monotonically_increasing_id, length, lpad,
rpad, format_number
from pyspark.sql.types import StructType, StructField,
StringType, DoubleType, DecimalType
from pyspark.sql.window import Window
import codecs
import sys
import os
def read_file_in_chunks(file_path,line_width):
  lines = [ ]
  with open(file_path, ‘rb’) as f:
    while True:
      chunk = f.read(line_width)
      if not chunk:
          break
line = chunk.decode(‘cp1047’,
errors=‘replace’).rstrip(‘\0’)
      lines.append(line)
  return lines
def write_aggregated_data(aggregated_data_formatted,
outfile_path, encoding=“cp1047”):
  output_rdd = aggregated_data_formatted.rdd.map(lambda
row: “”.join([str(cell) for cell in row]))
  with codecs.open(outfile_path,“w”, encoding=encoding)
as file:
      for line in output_rdd.collect( ):
        “““
        if len(line) <= 80:
```

file.write(line + ‘ ’ * (80-len (line)))

else:

```
    print(“line is truncated to 80 length”)
    file.write(line[0:80])
```

```
        ”””
        file.write(line)
print (‘Number of arguments:’, len(sys.argv), ‘arguments.’)
print(‘file_path_0:’, str(sys.argv[1]))
print(‘outfile_path:’, str(sys.argv[2]))
# Build Spark Session
spark =
SparkSession.builder.appName(“app_mdkdecce”).getOrCreate( )
# Set the required parameters
file_path_0=sys.argv[1]
outfile_path=sys.argv[2]
encoding = ‘cp1047’
#encoding = ‘cp037’
line_width_0 = 62
mdkdecce_widths=[41,8,1,8,4]
mdkdecce_positions=[0,41,49,50,58]
mdkdecce_lines = [ ]
mdkdecce_schema = StructType([
StructField(“ECCE_FILLER1”,StringType( ), True),
StructField(“ECCE_SRC_ID”,StringType( ), True),
StructField(“ECCE_INT”,StringType( ), True),
StructField(“ECCE_STR_DT”,StringType( ), True),
StructField(“ECCE_STR_TM”,StringType( ), True)
  ])
# Decode the input file
mdkdecce_decoded_lines =
read_file_in_chunks(file_path_0, line_width_0)
#print(decoded_lines)
# Build a structured schema out of the decoded file
mdkdecce_data = [tuple(line[pos:pos+width].strip( ) for pos,
width in zip(mdkdecce_positions, mdkdecce_widths)) for line
in mdkdecce_decoded_lines]
mdkdecce_df = spark.createDataFrame(mdkdecce_data,
mdkdecce_schema)
# df.show( )
# Apply required business logic after this section
df_MDKDECCE_0 =
mdkdecce_df.select(“ECCE_FILLER1”,“ECCE_SRC_ID”,“ECCE_INT”,
“ECCE_STR_DT”,“ECCE_STR_TM”)
df_MDKDECCE_0 =
df_MDKDECCE_0.withColumn(“SYS_ID_D”,when(trim(col(“ECCE_SRC
_ID”)) == lit(“BB”),‘550’)
otherwise(when(trim(col(“ECCE_SRC_ID”)) ==
lit(“CSS”),‘551’)
otherwise(when(trim(col(“ECCE_SRC_ID”)) ==
lit(“DMP”),‘552’)
otherwise(when(trim(col(“ECCE_SRC_ID”)) ==
lit (“DYNAMARK”),‘553’)
otherwise(when(trim(col(“ECCE_SRC_ID”)) ==
lit(“ECCO”),‘525’)
otherwise(when(trim(col(“ECCE_SRC_ID”)) == lit(“OSC-
INV”),‘554’)
otherwise(when(trim(col(“ECCE_SRC_ID”)) == lit(“PFS-
RMT”),‘555’)
otherwise(when(trim(col(“ECCE_SRC_ID”)) == lit(“RD”),‘556’)
otherwise(when(trim(col(“ECCE_SRC_ID”)) == lit(“RD-
CS”),‘557’)
otherwise(when(trim(col(“ECCE_SRC_ID”)) == lit(“RD-
EZMIS”),‘558’)
otherwise(when(trim(col(“ECCE_SRC_ID”)) == lit(“RD-
EZMCT”),‘559’)
otherwise(when(trim(col(“ECCE_SRC_ID”)) == lit(“RD-
EZMTL”),‘560’)
otherwise(when(trim(col(“ECCE_SRC_ID”)) == lit(“RD-
EZWIN”),‘561’)
otherwise(when(trim(col(“ECCE_SRC_ID”)) == lit(“RD-
NDR”),‘562’)
otherwise(when(trim(col(“ECCE_SRC_ID”)) == lit(“VOX-
MTL”),‘563’)
otherwise(when(trim(col(“ECCE_SRC_ID”)) == lit(“VOX-
TOR”),‘564’)
otherwise(when(trim(col(“ECCE_SRC_ID”)) ==
lit(“OPTIMA”),‘565’)
otherwise(when(trim(col(“ECCE_SRC_ID”)) == lit(“PSCL-
RES”),‘566’)
otherwise(when(trim(col(“ECCE_SRC_ID”)) ==
lit(“CART”),‘049’)
otherwise(when(trim(col(“ECCE_SRC_ID”)) == lit(“SAP-
RCT”),‘060’)
otherwise(when(trim(col(“ECCE_SRC_ID”)) == lit(“OLB-
SM”),‘073’)
otherwise(when(trim(col(“ECCE_SRC_ID”)) == lit(“OLB-
TMSG”),‘085’)
otherwise(when(trim(col(“ECCE_SRC_ID”)) == lit(“FRD-
PEGA”),‘770’)
otherwise(when(trim(col(“ECCE_SRC_ID”)) == lit(“TSYS-
CTR”),‘662’)
otherwise(when(trim(col(“ECCE_SRC_ID”)) ==
lit(“ZEDD”),‘663’)
otherwise(when(trim(col(“ECCE_SRC_ID”)) ==
lit(“DNH”),‘668’)
otherwise(when(trim(col(“ECCE_SRC_ID”)) == lit(“OL-
CCA”),‘003’)
otherwise(when(trim(col(“ECCE_SRC_ID”)) ==
lit(“CMG”),‘661’)
  otherwise(‘000’)))))))))))))))))))))))))))))
df_MDKDECCE_1 =
df_MDKDECCE_0.withColumn(“SYS_ID_D”,when(trim(col(“SYS_ID_D
”)) == ‘000’,when(trim(col(“ECCE_SRC_ID”)) ==
lit(“CCI”),‘567’))
otherwise(col(“SYS_ID_D”)))
df_MDKDECCE_2 =
df_MDKDECCE_1.withColumn(“SYS_ID”,lpad(col(“SYS_ID_D”),3,‘0
’))
df_MDKDECCE_3 =
df_MDKDECCE_2.withColumn(“STR_DT”,expr(“regexp_replace(ECCE
_STR_DT, ‘\\D’, ‘ ’)”))
df_TEMP1 =
df_MDKDECCE_3.select(col(“ECCE_FILLER1”),col(“SYS_ID”),col(
“ECCE_INT”),col(“STR_DT”),col(“ECCE_STR_TM”))
write_aggregated_data(df_TEMP1, outfile_path)
spark.stop( )
```

The above has described in detail a process for converting a program written in FOCUS to a program written in Python/PySpark. The same process can be used for converting various SQL-like legacy programming languages, such as FOCUS, SAS, and WebFOCUS, into other modern languages such as Python/PySpark, Scala/Spark, or Python/Snowpark.

The disclosed two-stage pipeline introduces a language-agnostic intermediate transformation configuration with a defined schema that constrains and normalizes legacy constructs, improving determinism and enabling automated validation and regeneration. Deterministic dataframe naming with monotonic indexing encodes pipeline state and directed dataflow, enabling reproducible compilation and automated deployment without manual intervention. Converting UPDATE statements to SELECT projections before translation reduces translation complexity and ensures consistent target API mappings, which can decrease processing time and memory footprint in translation. Structured parsing using a SQL parser, as well as normalized join/filter extraction, can help reduce parsing ambiguity and errors compared to manual migration. The use of the intermediate configuration file can enable parallelization, incremental rebuilds, and bulk upgrades by modifying templates or mapping tables once and regenerating many of the programs in the modern languages, which are specific improvements in computer-based code generation workflows.

It will be appreciated by one of ordinary skill in the art that the system and components shown in FIGS. 1 to 19 may include components and/or steps not shown in the drawings. For simplicity and clarity of the illustration, elements in the figures are not necessarily to scale, are only schematic and are non-limiting of the elements structures. It will be apparent to persons skilled in the art that a number of variations and modifications can be made without departing from the scope of the invention as defined in the claims.

Although certain components and steps have been described, it is contemplated that individually described components, as well as steps, may be combined together into fewer components or steps or the steps may be performed sequentially, non-sequentially, or concurrently. Further, although described above as occurring in a particular order, one of ordinary skill in the art having regard to the current teachings will appreciate that the particular order of certain steps relative to other steps may be changed. Similarly, individual components or steps may be provided by a plurality of components or steps. One of ordinary skill in the art having regard to the current teachings will appreciate that the components and processes described herein may be provided by various combinations of software, firmware, and/or hardware, other than the specific implementations described herein as illustrative examples.

The techniques of various embodiments may be implemented using software, hardware, and/or a combination of software and hardware. Various embodiments are directed to apparatus, e.g. a node which may be used in a communications system or data storage system. Various embodiments are also directed to non-transitory machine, e.g., computer, readable medium, e.g., ROM, RAM, CDs, hard discs, etc., which include machine readable instructions for controlling a machine, e.g., processor to implement one, more, or all of the steps of the described method or methods.

Some embodiments are directed to a computer program product comprising a computer-readable medium comprising code for causing a computer, or multiple computers, to implement various functions, steps, acts and/or operations, e.g. one or more or all of the steps described above. Depending on the embodiment, the computer program product can, and sometimes does, include different code for each step to be performed. Thus, the computer program product may, and sometimes does, include code for each individual step of a method, e.g., a method of operating a communications device, e.g., a wireless terminal or node. The code may be in the form of machine, e.g., computer, executable instructions stored on a computer-readable medium such as a RAM (Random Access Memory), ROM (Read Only Memory) or other type of storage device. In addition to being directed to a computer program product, some embodiments are directed to a processor configured to implement one or more of the various functions, steps, acts and/or operations of one or more methods described above. Accordingly, some embodiments are directed to a processor, e.g., CPU, configured to implement some or all of the steps of the method(s) described herein. The processor may be for use in, e.g., a communications device or other device described in the present application.

Numerous additional variations on the methods and apparatus of the various embodiments described above will be apparent to those skilled in the art in view of the above description. Such variations are to be considered within the scope of the current disclosure.

What is claimed is:

1. A method of converting a SQL-like language program into a modern programming language program, the method comprising:
receiving at a computing system an indication of a SQL-like language program to be converted;
parsing a master file of the SQL-like language to generate initialization data;
parsing a procedure file of the SQL-like language into logic statements and converting the logic statements into SQL statements;
storing the SQL statements in a transformation configuration file;
parsing the transformation configuration file and transforming each SQL statement into code in a modern programming language; and
generating a program by rendering the initialization data and generated code according to a rendering template.

2. The method of claim 1, wherein the SQL-like language is FOCUS.

3. The method of claim 1, wherein for each logic statement, the transformation configuration file further stores metadata information about the respective logic statement.

4. The method of claim 3, wherein the metadata information comprises one or more of:
defined input variable of the logic statement; and
defined output variable of the logic statement.

5. The method of claim 4, wherein the transformation configuration file further stores whole project input variables and output variables of the SQL-like language defined in the procedure file.

6. The method of claim 5, wherein each logic statement is categorized according to a type of SQL statement corresponding to the logic statement.

7. The method of claim 6, wherein the transformation configuration file stores the type of SQL statement of each logic statement.

8. The method of claim 1, wherein the modern programming language comprises one of:
Python/PySpark;
Scala/Spark; and
Python/Snowpark.

9. A system comprising:
a processor for executing instructions; and
a memory storing instructions, which when executed configure the system to perform a method comprising:
receiving at a computing system an indication of a SQL-like language program to be converted;
parsing a master file of the SQL-like language to generate initialization data;
parsing a procedure file of the SQL-like language into logic statements and converting the logic statements into SQL statements;
storing the SQL statements in a transformation configuration file;
parsing the transformation configuration file and transforming each SQL statement into code in a modern programming language; and
generating a program by rendering the initialization data and generated code according to a rendering template.

10. The system of claim 9, wherein the SQL-like language is FOCUS.

11. The system of claim 9, wherein for each logic statement, the transformation configuration file further stores metadata information about the respective logic statement.

12. The system of claim 11, wherein the metadata information comprises one or more of:
defined input variable of the logic statement; and
defined output variable of the logic statement.

13. The system of claim 12, wherein the transformation configuration file further stores whole project input variables and output variables of the SQL-like language defined in the procedure file.

14. The system of claim 13, wherein each logic statement is categorized according to a type of SQL statement corresponding to the logic statement.

15. The system of claim 14, wherein the transformation configuration file stores the type of SQL statement of each logic statement.

16. The system of claim 9, wherein the modern programming language comprises one of:
Python/PySpark;
Scala/Spark; and
Python/Snowpark.

17. A non-transitory computer readable memory storing instructions, which when executed by a processor of a system configure the system to perform a method according to claim 1.
